(19) United States
(12) Patent Application Publication
(10) Pub. No.: US 2010/0070731 A1
(43) Pub. Date: Mar. 18, 2010

(54) STORAGE SYSTEM HAVING ALLOCATION-ON-USE VOLUME AND POWER SAVING FUNCTION

(75) Inventors: Jun Mizuno, Yokohama (JP); Yuichi Taguchi, Sagamihara (JP); Masayasu Asano, Yokohama (JP); Masayuki Yamamoto, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/270,928

(22) Filed: Nov. 14, 2008

(30) Foreign Application Priority Data
Sep. 16, 2008 (JP) 2008-237066

(51) Int. Cl. G06F 12/02; G06F 1/32; G06F 12/00

(52) U.S. Cl. 711/170; 713/320; 711/E12.002; 711/E12.001

(57) ABSTRACT

A storage system includes physical memory devices, pool volumes, including real areas, an allocation-on-use (AOU) volume including virtual areas, and a controller allocating a non-allocated real area in a pool including the pool volumes to a virtual area corresponding to an address specified by a writing command when no real area is allocated to the virtual area, and writing data corresponding to the received writing command to the allocated real area. The controller moves data stored in all the real areas in a first pool volume allocated to the AOU volume to a second pool volume, and changes a power consuming status of the physical memory device constituting the first pool volume to a power saving mode after the data has been moved.

### CROSS REFERENCES TO RELATED APPLICATIONS

This application relates to and claims priority from Japanese Patent Application No. 2008-237066, filed on Sep. 16, 2008, the entire disclosure of which is incorporated herein by reference.

### BACKGROUND OF THE INVENTION

1. Field of the Invention

The present invention relates to control of power consumption of a storage system.

2. Description of the Related Art

As such a type of storage system, a storage system employing a massive array of idle (or inactive) disk (MAID) technique is known which is disclosed, for example, in JP-A-2005-157710. The storage system turns off a power supply of an HDD constituting a logical volume thereof when the logical volume to be saved in power is specified by a management server.

The storage system is not limited to the power saving function, but may have various functions. For example, a storage system having an allocation-on-use (AOU) volume is known (see, for example, JP-A-2003-15915). The AOU volume is a type of virtual logical volume is a logical volume of which the physical capacity is dynamically extended when a real area is allocated thereto in response to a writing command from a host. Data as a writing target is written to the real area allocated to the AOU volume.

### SUMMARY OF THE INVENTION

In the AOU technique in capacity, a real area is generally allocated to the AOU volume from a pool. The pool includes one or more pool volumes. The pool volume is a logical volume constituting the pool. The pool volume includes plural real areas.

It can be considered that the MAID technique is applied to the storage system having the AOU volume. In this case, for example, when the number of real areas allocated from the pool is small (that is, when the usage of the pool is small), a method of turning off power supplies of physical memory devices constituting the pool volumes can be considered.

However, in the storage system having the AOU volume, since plural data written to a single AOU volume are dispersed in the plural pool volumes, it is not preferable that the physical memory devices constituting the pool volumes are simply set to a power saving mode. When a physical memory device constituting a pool volume is simply changed to the power saving mode and an I/O (Input/Output) operation is performed on the pool volume, it is necessary to release the power saving mode of the physical memory device constituting the pool volume. Since it takes time for the physical memory device to become an I/O enabling status after the power saving mode of the physical memory device is released, the I/O performance on an AOU volume is deteriorated.

Accordingly, an object of the invention is to accomplish both not deteriorating the I/O performance of the AOU volume and reducing the power consumption of a storage system having the AOU volume.

A storage system moves data stored in all real areas, which are allocated to an AOU volume, in a first pool volume of plural pool volumes to a second pool volume of the plural pool volumes. Thereafter, the storage system sets the power consuming statuses of the physical memory devices constituting the first pool volume to the power saving mode.

### BRIEF DESCRIPTION OF THE DRAWINGS

FIG. 1 is a diagram illustrating a configuration of a computer system according to a first embodiment of the invention.

FIG. 2 is a diagram illustrating a configuration of a storage device according to the first embodiment of the invention.

FIG. 3 is a diagram illustrating a configuration of a data mapping table according to the first embodiment of the invention.

FIG. 4 is a diagram illustrating a configuration of a virtual volume management table according to the first embodiment of the invention.

FIG. 5 is a diagram illustrating a configuration of a pool configuration management table according to the first embodiment of the invention.

FIG. 6 is a diagram illustrating a configuration of a power status management table according to the first embodiment of the invention.

FIG. 7 is a diagram illustrating a configuration of a pool allocation management table according to the first embodiment of the invention.

FIG. 8 is a diagram illustrating a flow of a writing process according to the first embodiment of the invention.

FIG. 9 is a diagram illustrating a flow of a reading process according to the first embodiment of the invention.

FIG. 10 is a flow of a pool volume adding process according to the first embodiment of the invention.

FIG. 11 is a flow of a pool volume deleting process according to the first embodiment of the invention.

FIG. 12 is a flow of a device power saving setting process according to the first embodiment of the invention.

FIG. 13 is a flow of a device power saving releasing process according to the first embodiment of the invention.

FIG. 14 is a diagram illustrating a configuration of a management server according to the first embodiment of the invention.

FIG. 15 is a diagram illustrating a configuration of a pool volume management table according to the first embodiment of the invention.

FIG. 16 is a flow of a pool physical capacity reducing process according to the first embodiment of the invention.

FIG. 17 is a flow of a deleted pool volume determining process according to the first embodiment of the invention.

FIG. 18 is a flow of a pool physical capacity adding process according to the first embodiment of the invention.

FIG. 19 is a flow of an added pool volume determining process according to the first embodiment of the invention.

FIG. 20 is a diagram illustrating a configuration of a computer system according to a second embodiment of the invention.

FIG. 21 is a diagram illustrating an external connection management table according to the second embodiment of the invention.

FIG. 22 is a diagram illustrating a difference between the writing process according to the second embodiment of the invention and the writing process according to the first embodiment of the invention.

FIG. 23 is a diagram illustrating a difference between the reading process according to the second embodiment of the invention and the reading process according to the first embodiment of the invention.

FIG. 24 is a diagram illustrating a difference between the pool physical capacity reducing process according to the second embodiment of the invention and the pool physical capacity reducing process according to the first embodiment of the invention.

FIG. 25 is a diagram illustrating a difference between the pool physical capacity adding process according to the second embodiment of the invention and the pool physical capacity adding process according to the first embodiment of the invention.

FIG. 26 is a diagram illustrating a flow of an external connection setup process according to the second embodiment of the invention.

FIG. 27 is a diagram illustrating a flow of an external connection teardown process according to the second embodiment of the invention.

FIG. 28 is a diagram illustrating a difference between the pool physical capacity reducing process according to a third embodiment of the invention and the pool physical capacity reducing process according to the second embodiment of the invention.

FIG. 29 is a diagram illustrating a difference between the pool physical capacity adding process according to the third embodiment of the invention and the pool physical capacity adding process according to the second embodiment of the invention.

FIG. 30 is a diagram illustrating a configuration of a computer system according to a fourth embodiment of the invention.

FIG. 31 is a diagram illustrating a configuration of an FC-SW management table according to the fourth embodiment of the invention.

FIG. 32 is a flow of an SW power saving setting process according to the fourth embodiment of the invention.

FIG. 33 is a flow of an SW power saving releasing process according to the fourth embodiment of the invention.

FIG. 34 is a diagram illustrating a configuration of a connection configuration management table according to the fourth embodiment of the invention.

FIG. 35 is a diagram illustrating a difference between the pool physical capacity reducing process according to the fourth embodiment of the invention and the pool physical capacity reducing process according to the third embodiment of the invention.

FIG. 36 is a diagram illustrating a flow of an SW power saving instructing process according to the fourth embodiment of the invention.

FIG. 37 is a diagram illustrating a difference between the pool physical capacity adding process according to the fourth embodiment of the invention and the pool physical capacity adding process according to the third embodiment of the invention.

FIG. 38 is a diagram illustrating a flow of the SW power saving deletion instructing process.

FIG. 39 is a diagram illustrating a configuration of a physical device.

FIG. 40 is a diagram schematically illustrating the automatic capacity extension.

FIG. 41 is a diagram illustrating a configuration of an area allocation management table.

FIG. 42 is a diagram illustrating the correspondence between a condition of a source pool volume and a condition of a destination pool volume.

FIG. 43 is a diagram illustrating a configuration of an external storage device.

FIG. 44 is a diagram illustrating programs and tables of the storage device according to the second embodiment of the invention.

FIG. 45 is a diagram illustrating programs and tables of the external storage device.

FIG. 46 is a diagram illustrating a configuration of a real volume management table.

FIG. 47 is a diagram illustrating programs and tables of the management server according to the second embodiment of the invention.

FIG. 48 is a diagram illustrating the mapping between external volumes and real volumes.

FIG. 49 is a diagram illustrating programs and tables of the management server according to the third embodiment of the invention.

FIG. 50 is a diagram illustrating programs and tables of the storage device according to the third embodiment of the invention.

FIG. 51 is a diagram schematically illustrating the mapping release of the real volumes onto the external volumes according to the third embodiment of the invention.

FIG. 52 is a diagram illustrating programs and tables of the management server according to the fourth embodiment of the invention.

FIG. 53 is a diagram illustrating ports, functions, and tables of the FC-SW.

FIG. 54 is a diagram illustrating a connection example using the FC-SW.

### DESCRIPTION OF THE PREFERRED EMBODIMENTS

Hereinafter, embodiments of the invention will be described with reference to the accompanying drawings. In the following description, it is assumed that operations having a computer program as a subject are performed by a processor (CPU) executing the computer program.

### First Embodiment

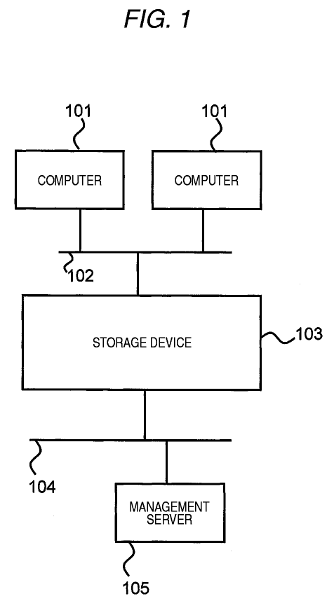

FIG. 1 is a diagram illustrating a configuration of a computer system according to a first embodiment of the invention.

A storage device 103 and plural (or one) computers 101 transmitting an I/O command (a writing command or a reading command) to the storage device 103 are connected to a storage area network (SAN) 102. The storage device 103 and a management server 105 managing the storage device 103 are connected to a local area network (LAN) 104. Communication networks 102 and/or 104 are not limited to the SAN and the LAN, but different types of networks may be used.

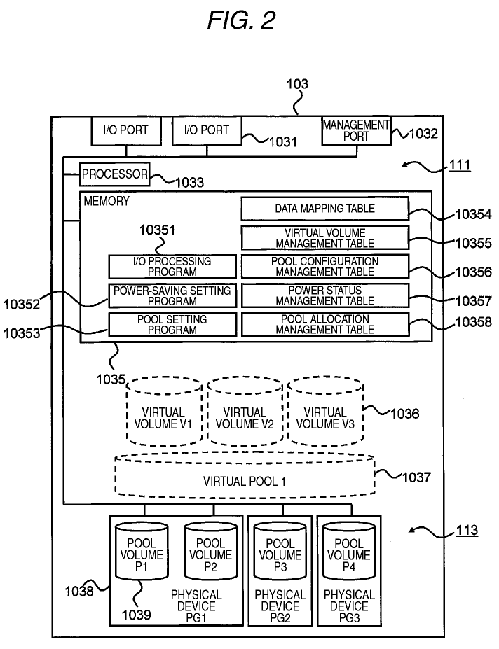

FIG. 2 is a diagram illustrating a configuration of the storage device 103.

The storage device 103 includes a controller 111 and a physical device group 113.

The controller 111 includes plural (or one) I/O ports 1031, a management port 1032, a processor 1033, and a memory 1035.

The I/O port 1031 is a port connected to a first communication network 102 and receives an I/O command from the computer 101.

The management port 1032 is a port connected to a second communication network 104 and receives various commands from the management server 105.

The processor 1033 is a micro processor such as a CPU (Central Processing Unit) and executes various computer programs stored in the memory 1035.

The memory 1035 stores the computer programs or management information. The computer programs include an I/O processing program 10351, a power saving setting program 10352, and a pool setting program 10353. The management information includes a data mapping table 10354, a virtual volume management table 10355, a pool configuration management table 10356, a power status management table 10357, and a pool allocation management table 10358.

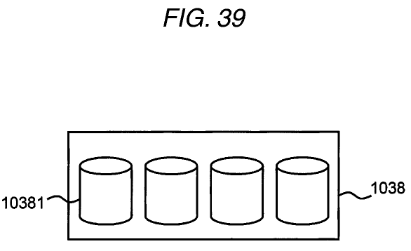

The physical device group 113 includes plural (or one) physical devices 1038. The physical devices 1038 are a parity group (also referred to as “RAID (Redundant Array of Independent (or Inexpensive) Disks) group or array group”) and include plural HDDs 10381 as shown in FIG. 39. Data are stored in the physical devices 1038 depending on the RAID level set for the devices 1038. A memory medium drive constituting the physical devices 1038 is not limited to the HDD, but may employ different types of drives.

A logical volume which is a logical memory device is formed based on a memory space of the physical devices 1038. As the logical volume, there is a normal type of logical volume provided to the computer 101 and a pool volume 1039 not provided to the computer 101. The pool volumes 1039 are elements of several virtual pools (hereinafter, simply referred to as “pool”) 1037. That is, the pool 1037 includes one or more pool volumes 1039. In this embodiment, it is assumed that pool volumes P1 and P2 are formed on the basis of physical device PG1, pool volume P3 is formed on the basis of physical device PG2, pool volume P4 is formed on the basis of physical device PG3, only pool 1 exists as the pool 1037, and pool 1 includes pool volumes P1 to P4. It is also assumed that virtual volumes V1 to V3 exist.

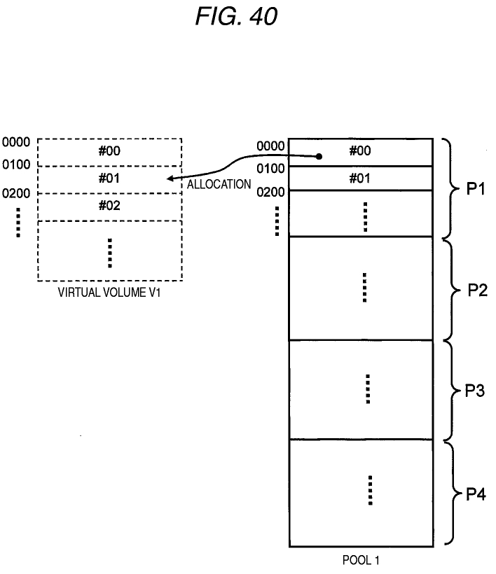

Virtual volumes 1036 (for example, V1 to V3) which are virtual logical volumes exist as the logical volumes provided to the computer 101. The virtual volume 1036 is an allocation-on-use (AOU) volume, that is, a volume to which the real areas are dynamically allocated in response to a writing operation. The dynamic allocation is as follows. That is, as shown in FIG. 40, virtual volume V1 includes plural virtual areas. On the other hand, pool volumes P1 to P4 constituting pool 1 include plural real areas. The virtual areas and the real areas are equal to each other in memory capacity. Here, addresses 0100 to 0199 (that is, virtual area #01) of virtual volume V1 is specified by a writing command from the computer 101. In this case, non-allocated real area #00 (memory area corresponding to addresses 0000 to 0099 of pool volume P1) in pool 1 is allocated to virtual area #01 as the writing destination and data to be written in accordance with the writing command are written to real area #00.

The numbers of physical devices 1038, pool volumes 1039, pools 1037, and virtual volumes 1036 are not limited to the example shown in FIG. 2.

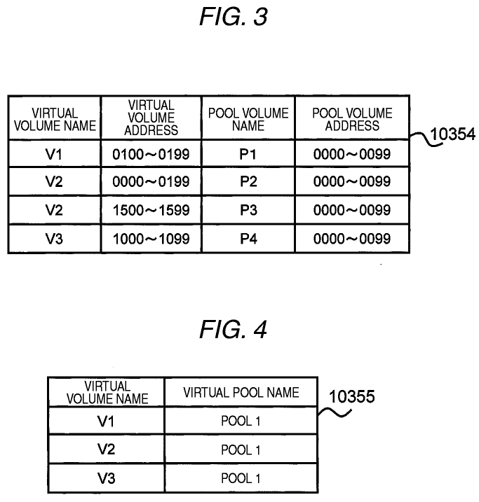

The above-mentioned tables 10354 to 10358 will be described now with reference to FIGS. 3 to 7.

FIG. 3 is a diagram illustrating a configuration of the data mapping table 10354.

The data mapping table 10354 indicates to what virtual areas the real areas are allocated. Specifically, for example, the following information elements of (3-1) to (3-4) are recorded every virtual area in the data mapping table 10354: (3-1) virtual volume name (name of virtual volume having virtual areas); (3-2) virtual volume address (address of virtual area in the virtual volume); (3-3) pool volume name (name of pool volume); and (3-4) pool volume address (address of real area in the pool volume). It can be seen from the example shown in FIG. 3 that the real areas (real areas having addresses “0000” to “0099”) in pool volume P1 are allocated to the virtual areas (virtual areas having addresses “0100” to “0199”) in virtual volume V1.

FIG. 4 is a diagram illustrating a configuration of the virtual volume management table 10355.

The virtual volume management table 10355 indicates from what pool 1037 the real areas can be allocated to the virtual volumes 1036. Specifically, for example, the following information elements (4-1) and (4-2) are recorded every volume in the virtual volume management table 10355: (4-1) virtual volume name (name of virtual volume); and (4-2) virtual pool name (name of pool). In the example shown in FIG. 4, it can be seen that the real areas can be allocated to virtual volumes V1 to V3 from pool 1.

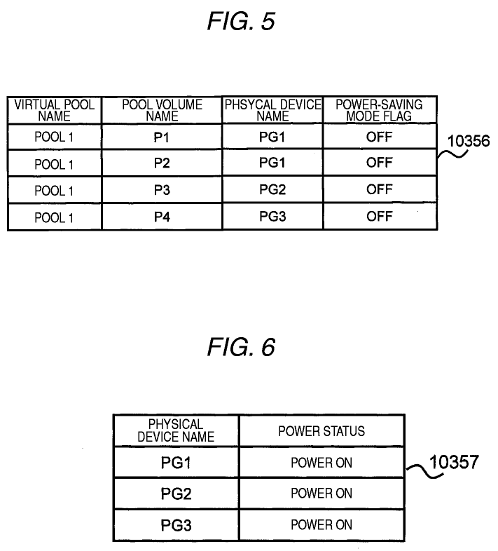

FIG. 5 is a diagram illustrating a configuration of the pool configuration management table 10356.

The pool configuration management table 10356 indicates what pool a pool volume belongs to, what physical device the pool volume is based on, and whether the pool volume is to be saved in power. Specifically, for example, the following information elements of (5-1) to (5-4) are recorded every pool volume in the pool configuration management table 10356: (5-1) virtual pool name (name of pool); (5-2) pool volume name (name of pool volume); (5-3) physical device name (name of physical device); and (5-4) power saving mode flag (flag indicating whether it is to be saved in power). It can be seen from the example shown in FIG. 5 that pool volume P1 belongs to pool 1, is based on physical device PG1, and is not to be saved in power (power saving mode flag “OFF.”

FIG. 6 is a diagram illustrating a configuration of the power status management table 10357.

The power status management table 10357 indicates in what the power consuming status of a physical device 1038 is. Specifically, for example, the following information elements of (6-1) and (6-2) are recorded every physical device 1038 in the power status management table 10357: (6-1) physical device name (name of physical device); and (6-2) power status (power consuming status). It can be seen from the example shown in FIG. 6 that the power consuming status of physical device PG1 is a status of power ON, that is, a power non-saving status. In this embodiment, the parity group is a group in which data are stored in a scheme according to a predetermined RAID level and all the HDDs 10381 of the parity group 1038 are based on individual pool volumes 1039 based on the parity group 1038. Accordingly, in this embodiment, the power consuming status of the HDD 10381 is changed to the power saving mode in the unit of physical devices (parity groups). The “power saving mode” means a status (that is, power saving status) where the power consumption is smaller than that in the I/O enabling status and specific examples thereof include a power OFF status and a status where a disk rotates in the HDD 10381 at a low speed.

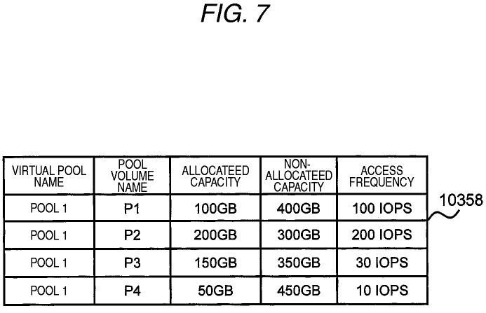

FIG. 7 is a diagram illustrating the pool allocation management table 10358.

The pool allocation management table 10358 indicates the pool volumes 1039 constituting the pool volumes 1037, the total capacity of the allocated real areas in the pool volumes 1037, the total capacity of the non-allocated real areas, and the I/O frequency. Specifically, for example, the following information elements of (7-1) to (7-5) are recorded every pool volume in the pool allocation management table 10358: (7-1) virtual pool name (name of pool); (7-2) pool volume name (name of pool volume); (7-3) allocated capacity (total capacity of allocated real area); (7-4) non-allocated capacity (total capacity of non-allocated real area) ; and (7-5) I/O frequency (I/O frequency on pool volume). Paying attention to pool volume P1, it can be seen from the example shown in FIG. 7 that pool volume P1 belongs to pool 1, the total capacity of the real areas allocated from pool volume P1 is 100 GB (Giga Byte), the total capacity of the non-allocated real areas in pool volume P1 is 400 GB (that is, the capacity of pool volume P1 is 500 GB (=100 GB+400 GB), and the I/O frequency on pool volume P1 is 100 IOPS (IO per second: the number of I/O operations for 1 second).

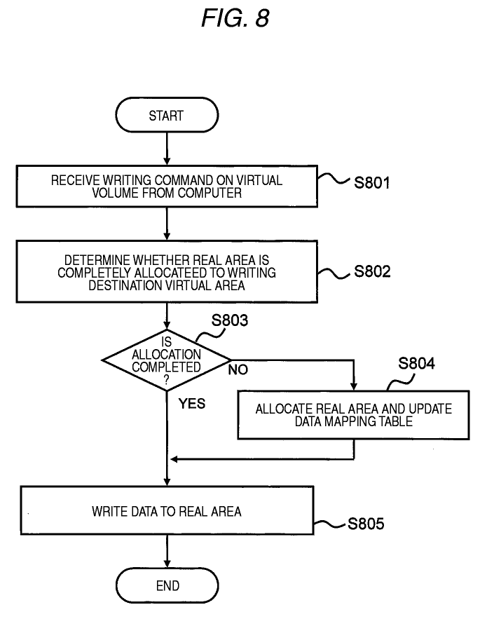

FIG. 8 is a diagram illustrating a flow of the writing process. The writing process is performed by the I/O processing program 10351. The I/O processing program 10351 is a program used to process an I/O command from the computer 101.

In S801, the I/O processing program 10351 receives a writing command specifying a virtual area of a virtual volume from the computer 101. It is assumed that the writing command includes an LUN (Logical Unit Number) corresponding to virtual volume V1 and an LBA (Logical Block Address) corresponding to a writing destination virtual area.

In S802, the I/O processing program 10351 determines whether the real areas are already allocated to the writing destination virtual area of virtual volume V1 with reference to the data mapping table 10354. Here, when a record including an address of the destination virtual area exists in the table 10354, the determination result of S802 is affirmative.

When the determination result of S802 is affirmative (YES in S803), the process of S805 is performed. That is, in S805, the I/O processing program 10351 writes data corresponding to the writing command received in S801 to the real area allocated to the destination virtual area. At this time, the pool allocation management table 10358 is updated. Specifically, for example, when an allocated real area exists in pool volume P1, the access frequency corresponding to pool volume P1 in the table 10358 is updated.

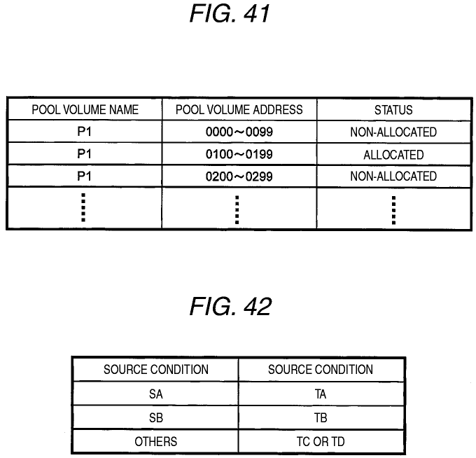

On the other hand, when the determination result of S802 is negative (NO in S803), the process of S804 is performed. That is, in S804, the I/O processing program 10351 specifies the pool corresponding to virtual volume V1 with reference to the virtual volume management table 10355, specifies the non-allocated real area in the specified pool, and allocates the specified non-allocated real area to the destination virtual area. Specifically, the non-allocated real area is specified with reference to an area allocation management table shown in FIG. 41. The table is stored in the memory 1035 and indicates whether the allocation to the virtual area is completed every real area. When the real area is allocated to the destination virtual area, the status corresponding to the allocated real area in the table is updated from the non-allocated to the allocated. The record including information on the destination virtual area (virtual volume name and virtual volume address) is added to the data mapping table 10354 and information on the real area (pool volume name and pool volume address) allocated to the destination virtual area is written to the record. In addition, the pool allocation management table 10358 is updated. Specifically, for example, when the allocated real area exists in pool volume P1, the allocated capacity corresponding to pool volume P1 in the table 10358 increases by the capacity of the real area, and the non-allocated capacity corresponding to pool volume P1 decreases by the capacity of the real area.

After S804, the process of S805 is performed. That is, the data is written to the allocated real area.

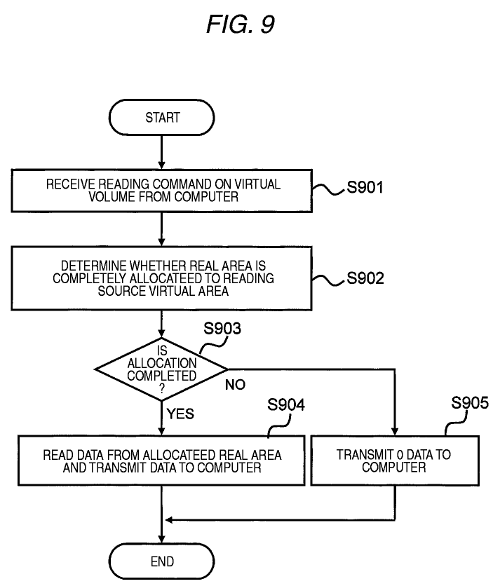

FIG. 9 is a diagram illustrating a flow of the reading process. The reading process is performed by the I/O processing program 10351.

In S901, the I/O processing program 10351 receives a reading command specifying a virtual area of a virtual volume from the computer 101. It is assumed that the reading command includes an LUN corresponding to virtual volume V1 and an LBA corresponding to a reading source virtual area.

In S902, the I/O processing program 10351 determines whether a real area is already allocated to the source virtual area of virtual volume V1 with reference to the data mapping table 10354.

When the determination result of S902 is affirmative (YES in S903), the process of S904 is performed. That is, in S904, the I/O processing program 10351 reads data from the real area allocated to the source virtual area and transmits the read data to the computer 101. At this time, the pool allocation management table 10358 is updated. Specifically, for example, when an allocated real area exists in pool volume P1, the access frequency corresponding to pool volume P1 in the table 10358 is updated.

On the other hand, when the determination result of S902 is negative (NO in S903), the process of S905 is performed. That is, in S905, the I/O processing program 10351 transmits 0 data (data indicating “0” as a value) to the computer 101.

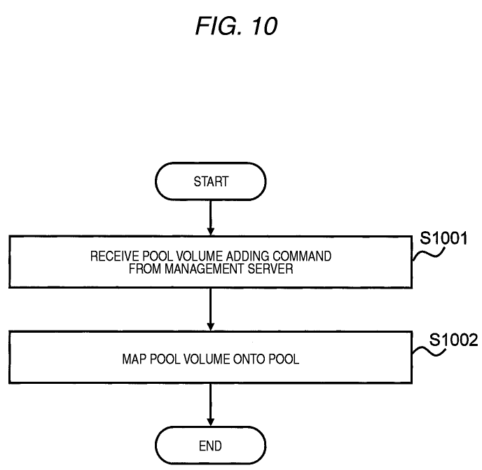

FIG. 10 is a diagram illustrating a flow of a pool volume adding process. The pool volume adding process is performed by a pool setting program 10353. The pool setting program 10353 is a program used to add/delete a pool volume to/from a pool.

In S1001, the pool setting program 10353 receives a pool volume adding command from the management server 105. In the adding command, it is specified to what pool a logical volume should be added (for example, virtual pool name and logical volume name are included therein). In the following description with reference to FIG. 10, it is assumed that the volume and the pool specified by the adding command are called “target volume” and “target pool.”

In S1002, the pool setting program 10353 maps the target volume onto the target pool. Specifically, the pool setting program 10353 adds the name of the target pool to a record including the target volume name in the pool configuration management table 10356. The power saving mode flag in the record is “OFF.”

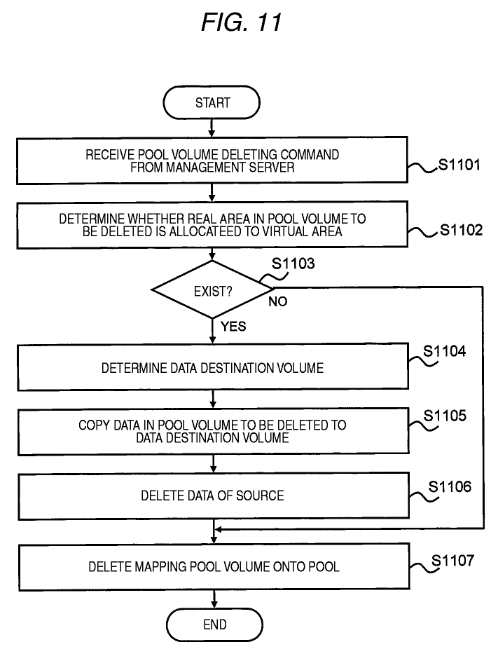

FIG. 11 is a diagram illustrating a flow of a pool volume deleting process. The pool volume deleting process is performed by the pool setting program 10353.

In S1101, the pool setting program 10353 receives a pool volume deleting command from the management server 105. In the pool volume deleting command, it is specified from what pool a pool volume should be deleted (for example, virtual pool name and pool volume name to be deleted are included therein). It is assumed that the volume and the pool specified by the deleting command are called “target volume” and “target pool.”

In S1102, the pool setting program 10353 determines whether the real areas allocated to several virtual volumes 1036 exist in the target pool volume with reference to the area allocation management table (or the data mapping table 10354) shown in FIG. 41.

When the determination result of S1102 is negative (NO in S1103), the process of S1107 is performed. That is, in S1107, the pool setting program 10353 deletes the mapping of the pool volume onto the target pool. Specifically, the target pool name is deleted from the record including the target pool volume name in the pool configuration management table 10356.

When the determination result of S1102 is affirmative (YES in S1103), the processes of S1104 to S1106 are performed.

That is, in S1104, the pool setting program 10353 determines a destination pool volume. The destination pool volume is a pool volume satisfying several conditions of the following conditions of (11-1) to (11-5): (11-1) the pool volume exists in the target pool; (11-2) the pool volume is a pool volume other than the source pool volume; (11-3) the pool volume is based on a physical device other than the physical device constituting the source pool volume; (11-4) the pool volume has the power saving mode flag of “OFF); and (11-5) the pool volume satisfies one of condition TA to condition TD: (condition TA) the allocated capacity (the total capacity of the allocated real areas) is smallest in the pool volume other than the source pool volume; (condition TB) the I/O frequency is smallest in the pool volume other than the source pool volume; (condition TC) the pool volume is one or more pool volumes allocated to plural pool volumes (of which the power saving mode flags are all “OFF”) other than the source pool volume in the target pool to uniformize the capacity; and (condition TD) the pool volume is one or more pool volumes allocated to plural pool volumes (of which the power saving mode flags are all “OFF”) other than the source pool volume in the target pool to uniformize the I/O frequency. What condition is used in the (11-5) depends on the condition of the source pool volume as shown in FIG. 42. That is, it depends on the following conditions of (11-5-1) to (11-5-3): (11-5-1) condition TA is used when the source pool volume is a pool volume suitable for condition SA (the allocated capacity in the target pool is smallest); (11-5-2) condition TB is used when the source pool volume is a pool volume suitable for condition SB (the I/O frequency in the target pool is smallest); and (11-5-3) one of conditions TC and TD is used when the source pool volume is a pool volume not suitable for any of condition SA and condition SB. The “source pool volume” is a pool volume of which the mapping onto the pool is deleted. The pool volume is also a pool volume to be reduced in power. That is, since no access occurs on the volume of which the mapping is deleted, the pool volume is a target to be in the power saving mode. The condition suitable for the source pool volume may be grasped by inquiring of the management server 105, or information (information indicating which of conditions SA, SB, and other conditions) indicating the condition suitable for the source pool volume may be included in the pool volume deleting command from the management server 105.

In S1105, the pool setting program 10353 moves (copies) data stored in the allocated real area in the source pool volume (target pool volume) to the non-allocated real area in the destination pool volume and updates the data mapping table 10354. Specifically, the information (name of source pool volume and address of the real area thereof) on the allocated real area of the data source in the data mapping table 10354 is updated into the information (name of destination pool volume and address of the real area of the destination) on the real area of the data destination. The status of the real area as the data source in the area allocation management table shown in FIG. 40 is updated from the “allocated” to the “non-allocated” and the status of the real area as the data destination is updated from the “non-allocated” to the allocated.”

In S1106, the pool setting program 10353 checks that the data in the real area as the data source is equal to the data in the real area as the data destination, and then deletes the data in the real area as the data source.

The process of S1107 is performed after S1106. That is, the source pool volume is deleted from the pool specified by the deleting command received in S1101.

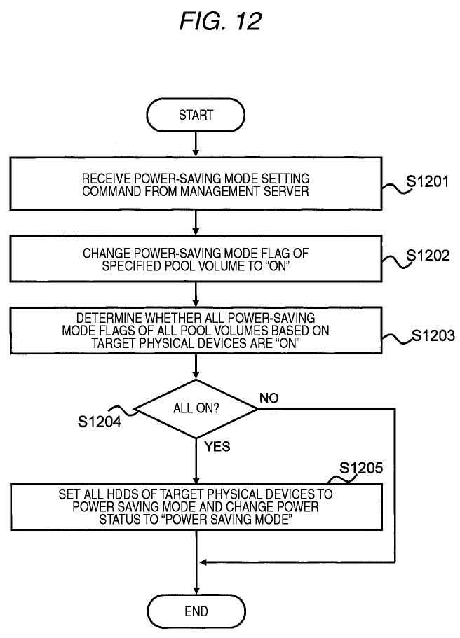

FIG. 12 is a diagram illustrating a flow of a device power saving setting process. The device power saving setting process is performed by a power saving setting program 10352. The power saving setting program 10352 is a program used to control the power saving/power non-saving of the HDDs constituting the physical devices. The process of FIG. 12 is carried out, for example, on the pool volume specified by the deleting command from the management computer.

In S1201, the power saving setting program 10352 receives a power saving mode setting command from the management server 105. The power saving mode setting command includes the name of a pool volume as a power saving mode target (referred to as “target pool volume” in the following description with reference to FIG. 12).

In S1202, the power saving setting program 10352 sets the target pool volume as the power saving target. That is, the power saving setting program 10352 changes the power saving mode flag (flag in the pool configuration management table 10356) corresponding to the target pool volume from “OFF” to “ON.”

In S1203, the power saving setting program 10352 determines whether all the other pool volumes based on the physical device (referred to as “target physical device” in the following description with reference to FIG. 12) constituting the target pool volume are the power saving targets. That is, it is determined whether the power saving mode flags of all the pool volumes based on the target physical device are set to “ON.”

When the determination result of S1203 is negative (NO in S1204), the device power saving setting process is ended.

When the determination result of S1203 is affirmative (YES in S1204), the process of S1205 is performed. That is, in S1205, the power saving setting program 10352 sets the power consuming status of all the HDDs constituting the target physical device to the power saving mode. The power saving setting program 10352 updates the power status corresponding to the target physical device in the power status management table 10357 from “power ON” to “power saving mode.”

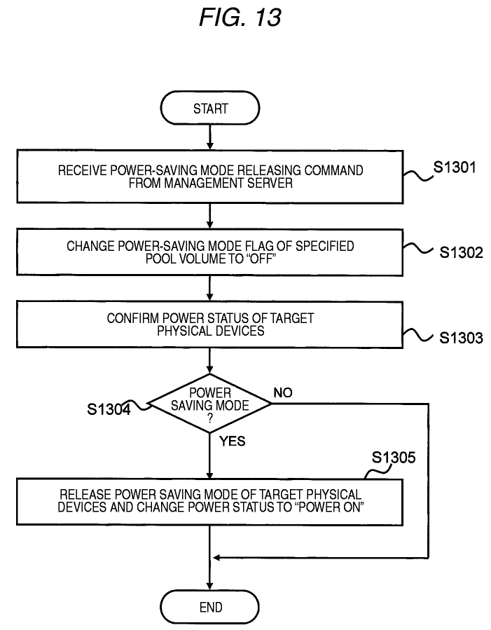

FIG. 13 is a diagram illustrating a flow of a device power saving releasing process. The device power saving releasing process is performed by the power saving setting program 10352.

In S1301, the power saving setting program 10352 receives a power saving mode releasing command from the management server 105. The power saving mode releasing command includes, for example, the name of the pool volume (referred to as “target pool volume”) in the following description with reference to FIG. 13) as a power saving mode releasing target (power non-saving target).

In S1302, the power saving setting program 10352 sets the target pool volume as the power non-saving target. That is, the power saving setting program 10352 changes the power saving mode flag (flag in the pool configuration management table 10356) corresponding to the target pool volume from “ON” to “OFF.”

In S1303, the power saving setting program 10352 determines whether the power status of the physical device (referred to as “target physical device” in the following description with reference to FIG. 13) constituting the target pool volume is in the “power saving mode.”

When the determination result of S1303 is negative (NO in S1304), the device power saving releasing process is ended.

When the determination result of S1303 is affirmative (YES in S1304), the process of S1305 is performed. That is, in S1305, the power saving setting program 10352 deletes the power saving mode of all the HDDs constituting the target physical device (for example, turns on the power supply of the HDDs). The power saving setting program 10352 updates the power status corresponding to the target physical device in the power status management table 10357 from “power saving mode” to “power ON.”

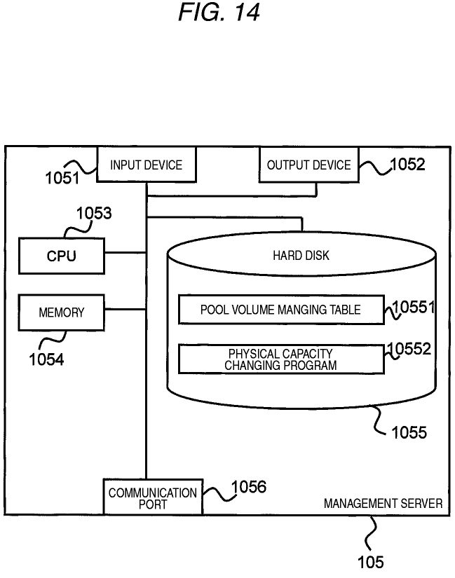

FIG. 14 is a diagram illustrating a configuration of the management server 105.

The management server 105 is a kind of computer and includes an input device 1051, an output device 1052, a CPU 1053, memory resources (such as memory 1054 and HDD 1055), and a communication port 105. The input device 1051 includes, for example, a keyboard or a pointing device operated by a manager. The output device 1052 includes, for example, a display device such as a liquid crystal display device. The CPU 1053 executes a physical capacity changing program 10552 which is a computer program loaded onto the memory 1054 from the HDD 1055. The HDD 1055 stores a pool volume management table 10551 in addition to the program 10552. The communication port 1056 is a port connected to the second communication network 104 (see FIG. 1).

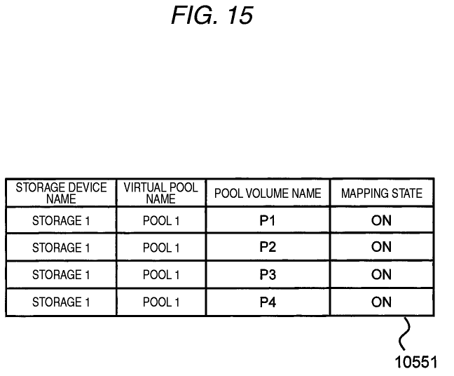

FIG. 15 is a diagram illustrating a configuration of the pool volume management table 10551.

The pool volume management table 10551 indicates what storage devices the pool volumes exist in and what pool the pool volumes are mapped onto. Specifically, for example, the following information elements of (15-1) to (15-4) are recorded every pool volume in the pool volume management table 10551: (15-1) storage device name (name of storage device); (15-2) virtual pool name (name of pool); (15-3) pool volume name (name of pool volume); and (15-4) mapping status (whether a pool volume is mapped onto a pool). The mapping status “ON” means that the corresponding pool volume is mapped onto a pool (that is, the pool volume belongs to the pool). In the example shown in FIG. 15, paying attention to pool volume P1, it can be seen that pool volume P1 is a storage device having the storage device name of “storage 1”, belongs to pool 1, and is mapped onto pool 1.

FIG. 16 is a diagram illustrating a flow of a pool physical capacity reducing process. The pool physical capacity reducing process is performed by a physical capacity changing program 10552. The program 10552 is a program used to control the increase/decrease in capacity of a pool.

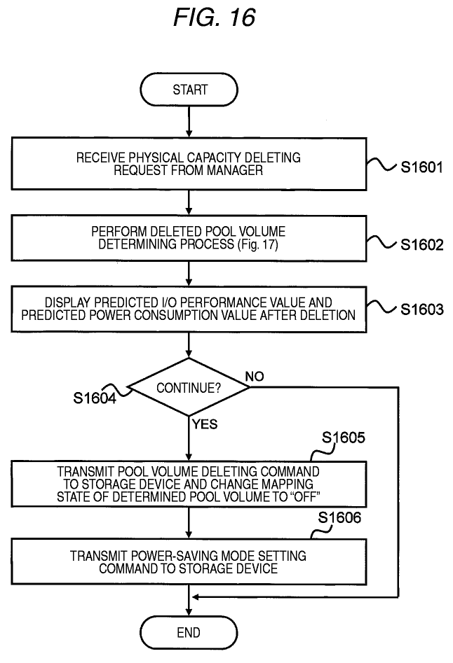

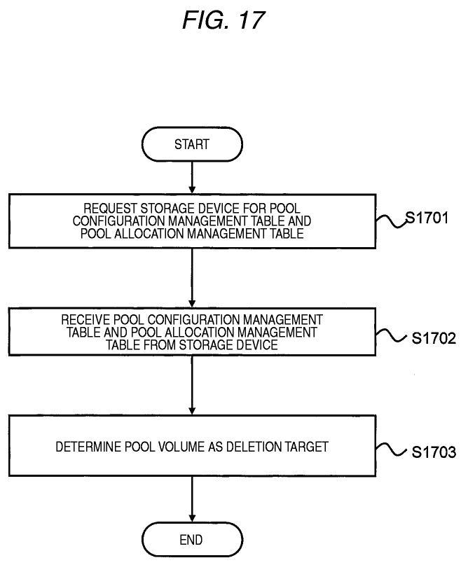

In S1601, the physical capacity changing program 10552 receives a physical capacity reducing request from a manager. In the request, the name of a pool (referred to as “target pool” in the following description with reference to FIGS. 16 and 17) as a capacity reducing target is specified.

In S1602, the physical capacity changing program 10552 performs a deleted pool volume determining process for determining a pool volume to be deleted from the target pool. This process will be described later in detail with reference to FIG. 17.

In S1603, the physical capacity changing program 10552 calculates a predicted I/O performance value and a predicted power consumption value when the mapping of the pool volume (referred to as “target pool volume” in the following description with reference to FIG. 16) determined in S1602 on the target pool is deleted, and displays the calculated predicted I/O performance value and the calculated predicted power consumption value on the output device 1052.

Here, the “predicted I/O performance value” is a predicted value of the I/O performance with respect to the virtual volume (virtual volumes V1 to V3 in the examples shown in FIGS. 2 and 3) to which the real areas are allocated from the target pool. The “predicted power consumption value” is a predicted value of the power consumption of the storage device 103.

When non-continuation is determined by the manager after S1603 (NO in S1604), the pool physical capacity reducing process is ended. It is not limited to the manager's continuation or non-continuation determination of the physical capacity reducing process. That is, the continuation or non-continuation may be automatically determined using the “predicted I/O performance value” or the “predicted power consumption value” and a threshold value.

On the other hand, when continuation is determined by the manager after S1603 (YES in S1604), the processes of S1605 and S1606 are performed.

That is, in S1605, the physical capacity changing program 10552 transmits the pool volume deleting command specifying the target pool and the target pool volume to the storage device 103 (whereby the pool volume deleting process shown in FIG. 11 is performed in the storage device 103). The physical capacity changing program 10552 changes the mapping status of the target pool volume in the pool volume management table 10551 from “ON” to “OFF.”

In S1606, the physical capacity changing program 10552 transmits the power saving mode setting command specifying the target pool volume to the storage device 103. Accordingly, in the storage device 103, the device power saving setting process shown in FIG. 12 is performed. The process of S1606 is performed, for example, when the pool setting program 10353 reports that the pool volume deleting process shown in FIG. 11 is completed.

FIG. 17 is a diagram illustrating a flow of a deleted pool volume determining process.

In S1701, the physical capacity changing program 10552 requests the storage device 103 for the pool configuration management table 10356 and the pool allocation management table 10358.

In S1702, the physical capacity changing program 10552 receives the pool configuration management table 10356 and the pool allocation management table 10358 from the storage device 103.

In S1703, the physical capacity changing program 10552 determines a pool volume suitable for a specific condition as a deletion target pool volume with reference to the pool configuration management table 10356 and the pool allocation management table 10358 received in S1702. Specifically, the pool volume satisfying the following conditions SA to SC as the deletion target pool volume: (condition SA) the pool volume is a pool volume having the smallest allocated capacity in the target pool; (condition SB) the pool volume is a pool volume having the smallest I/O frequency in the target pool; and (condition SC) the pool volume is a pool volume based on the physical device having the smallest number of pool volumes of which the power saving mode flag is set to “OFF.” The pool volume satisfying one of conditions SA to SC has a power saving mode flag of “OFF.”

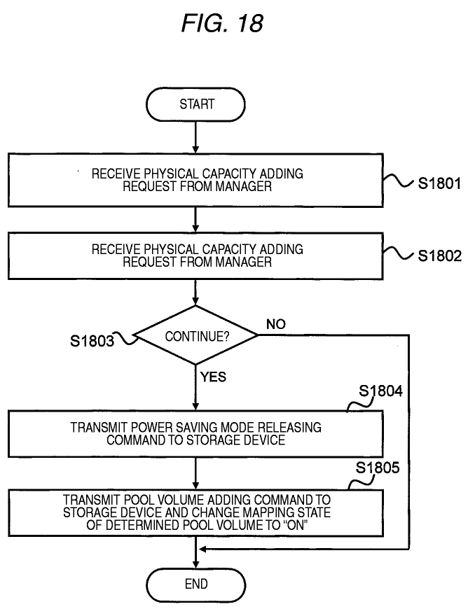

FIG. 18 is a diagram illustrating a flow of a pool physical capacity adding process. The pool physical capacity adding process is performed by the physical capacity changing program 10552.

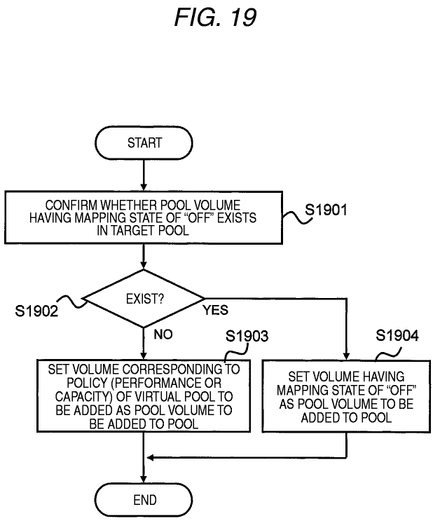

In S1801, the physical capacity changing program 10552 receives a physical capacity adding request from the manager. In the request, for example, the name of a pool (referred to as “target pool” in the following description with reference to FIGS. 18 and 19) as a capacity addition target is specified.

In S1802, the physical capacity changing program 10552 performs the added pool volume determining process of determining a pool volume to be added to the target pool. This process will be described later in detail with reference to FIG. 19.

When the non-continuation is determined by the manager after S1802 (NO in S1803), the pool physical capacity adding process is ended.

On the other hand, when the continuation is determined by the manager after S1802 (YES in S1803), the physical capacity changing program 10552 transmits to the storage device 103 a power saving mode releasing command indicating the pool volume (referred to as “target pool volume” in the following description with reference to FIG. 18) determined in S1802 (S1804). Accordingly, the device power saving releasing process described with reference to FIG. 13 is performed in the storage device 103.

In S1805, the physical capacity changing program 10552 transmits to the storage device 103 the pool volume adding command indicating the target pool volume. Accordingly, the pool volume adding process shown in FIG. 10 is performed in the storage device 103. The process of S1805 is performed, for example, when the power saving setting program 10352 reports that the device power saving releasing process shown in FIG. 13 is completed.

FIG. 19 is a diagram illustrating a flow of the added pool volume determining process.

In S1901, the physical capacity changing program 10552 determines whether the pool volume of which the mapping status is “OFF” belongs to the target pool with reference to the pool volume management table 10552.

When the determination result of S1901 is negative (NO in S1902), the process of S1903 is performed. That is, in S1903, the physical capacity changing program 10552 determines as the pool volume to be added to the target pool the logical volume (volume based on several physical devices) suitable for the policy (for example, the I/O performance or capacity) on the target pool.

When the determination result of S1901 is affirmative (NO in S1902), the process of S1904 is performed. That is, in S1904, the physical capacity changing program 10552 determines the pool volume of which the mapping status onto the target pool is “OFF” as the pool volume to be added to the target pool.

Hitherto, the first embodiment of the invention is described.

According to the first embodiment of the invention, the data stored in the real area (source real area in this paragraph), which is allocated to the virtual area in the virtual volume, in the pool volume (target volume in this paragraph) to be deleted from the pool are moved to the non-allocated real area (destination real area in this paragraph) in the pool volume based on the physical device other than the physical device (target physical device in this paragraph) constituting the target pool. Then, the power consuming statuses of all the HDDs constituting the target physical device are changed to the power saving mode. The real area mapped onto the virtual area is changed from the source real area to the destination real area. Accordingly, it is possible to reduce the power consumption of the storage device 103 and not to deteriorate the I/O performance with respect to the virtual volume.

### Second Embodiment

A second embodiment of the invention will be described now. The difference from the first embodiment is mainly described and the description common to the first embodiment is omitted or simplified.

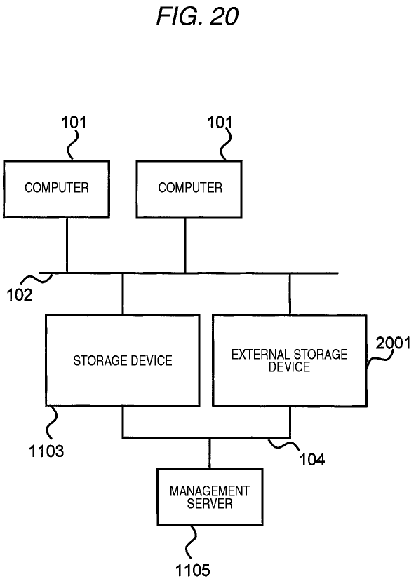

FIG. 20 is a diagram illustrating a computer system according to the second embodiment of the invention.

In addition to the computer 101 and the storage device 1103, an external storage device 2001 is connected to the SAN 102. Similarly, the external storage device 2001 as well as the storage device 1103 and the management server 1105 is connected to the LAN 104. The number of external storage devices 2001 is not limited to 1, but may be more than 1.

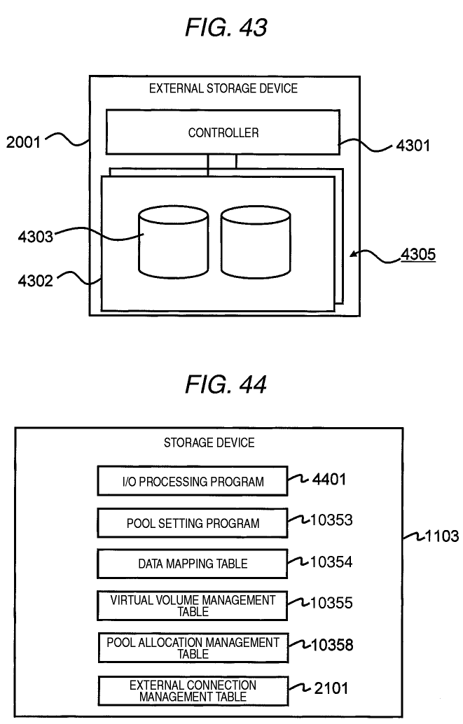

The external storage device 2001 includes a controller 4301 and a physical memory device group 4305 as shown in FIG. 43. The controller 4301 has the same configuration as the controller 111 (see FIG. 2). The physical memory device group 4305 includes plural physical devices 4302. One or more logical volumes 4303 are formed on the basis of the physical devices 4302.

The logical volume 4303 is a physical logical volume and the pool volume in the storage device 1103 is a virtual logical volume. The logical volume 4303 is mapped onto the virtual pool volume. Specifically, for example, as shown in FIG. 48, logical volumes RP1 to RP4 as the physical pool volumes in the external storage device 2001 are mapped onto virtual pool volumes VP1 to VP4. In the below description, the pool volume (virtual pool volume) is called “external volume” and the logical volume (physical pool volume) in the external storage device 2001 is called “real volume.” Each external volume is an element of a pool and includes plural real areas. Each real volume includes memory areas corresponding to the real areas. Plural real volumes in another external storage device may be mapped onto the plural external volumes in the same pool.

In this embodiment, as shown in FIG. 44, the I/O processing program 4401 in the storage device 1103 has a function different from that of the I/O processing program 10351 of the first embodiment. An external connection management table 2101 is stored in the memory of the storage device 1103.

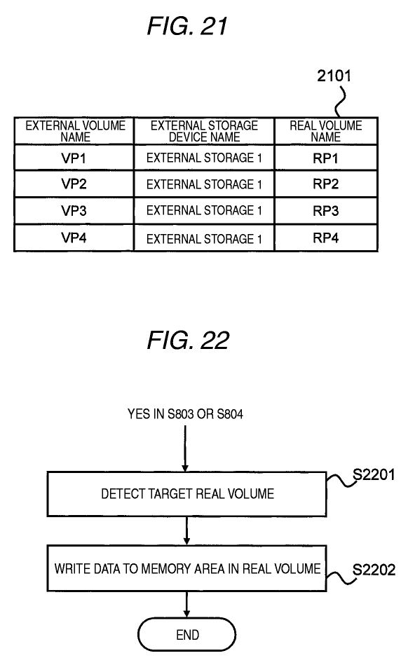

FIG. 21 is a diagram illustrating a configuration of the external connection management table 2101.

The external connection management table 2101 indicates onto what external volume a real volume is mapped as the pool volume. The following information elements of (21-1) to (21-3) are recorded every external volume in the external connection management table 2101: (21-1) external volume name (name of external volume); (21-2) external storage device name (name of external storage device); and (21-3) real volume name (name of real volume). Paying attention to external volume VP1, it can be seen from the example shown in FIG. 21 that real volume RP1 is mapped onto external volume VP1 and real volume RP1 exists in the external storage device having an external storage device name of “external storage 1.”

FIG. 22 is a diagram illustrating a difference between the writing process according to the second embodiment and the writing process according to the first embodiment.

The processes of S2201 and S2202 shown in FIG. 22 are performed instead of S805 after YES in S803 or S804.

In S2201, the I/O processing program 4401 detects a real volume (referred to as “target real volume” in the description with reference to FIG. 22) mapped onto the external volume having the real area allocated to the destination virtual area with reference to the external connection management table 2101.

In S2202, the I/O processing program 4401 writes data to the memory area (referred to as “target memory area” in the description with reference to FIG. 22) corresponding to the real area allocated to the destination virtual area in the target real volume. Specifically, the I/O processing program 4401 transmits to the external storage device 2001 the LUN corresponding to the target real volume and the writing command including the address of the target memory area. Accordingly, the data to be written are written to the memory area, which is specified by the writing command, in the target real volume specified by the writing command by the controller 4301 of the external storage device 2001.

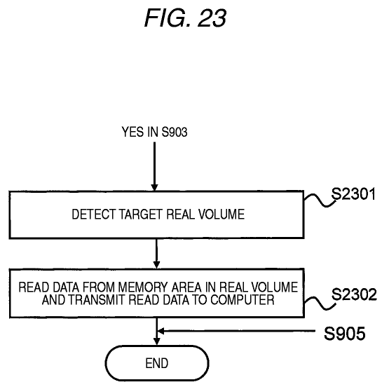

FIG. 23 is a diagram illustrating a difference between the reading process according to the second embodiment and the reading process according to the first embodiment.

The processes of S2301 and S2202 shown in FIG. 23 are performed instead of S904 after YES in S903 shown in FIG. 9.

In S2301, the I/O processing program 4401 detects the real volume (referred to as “target real volume” in the description with reference to FIG. 23) mapped onto the external volume having the real area allocated to the source virtual area with reference to the external connection management table 2101.

In S2302, the I/O processing program 4401 reads data as a reading target from the memory area (referred to as “target memory area” in the description with reference to FIG. 23), which corresponds to the real area allocated to the source virtual area, in the target real volume and transmits the read data to the computer 101. Specifically, the I/O processing program 4401 transmits to the external storage device 2001 the LUN corresponding to the target real volume and the reading command including the address of the target memory area. Accordingly, the data as a reading target are read from the memory area, which is specified by the reading command, in the target real volume specified by the reading command and are sent to the storage device 1103 by the controller 4301 of the external storage device 2001. The data are sent from the storage device 1103 to the computer 101.

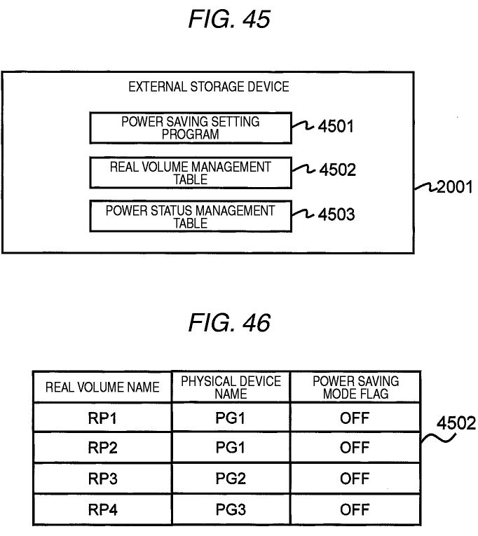

In the second embodiment, as shown in FIG. 45, a power saving setting program 4501 and a power status management table 4503 may be disposed in the external storage device 2001 (specifically, are stored in the memory of the controller 4301) A real volume management table 4502 is also stored in the memory of the external memory device 2001. As shown in FIG. 46, the real volume name, the physical device name, and the power saving mode flag of each real volume are recorded in the real volume management table 4502.

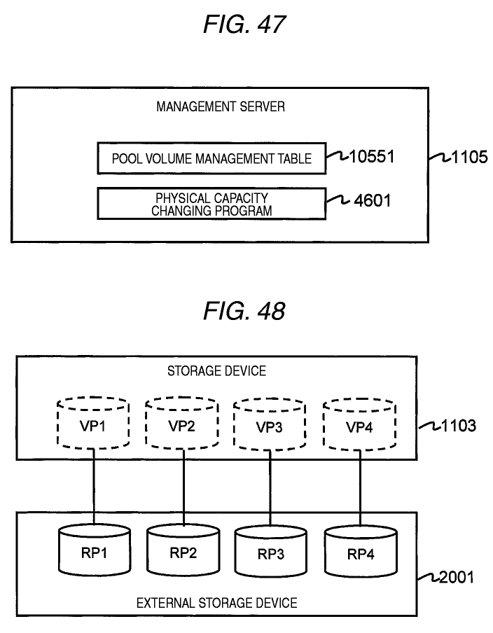

In the second embodiment, as shown in FIG. 47, the physical capacity changing program 4601 executed by the management server 1105 has a function different from that of the physical capacity changing program 10552 according to the first embodiment.

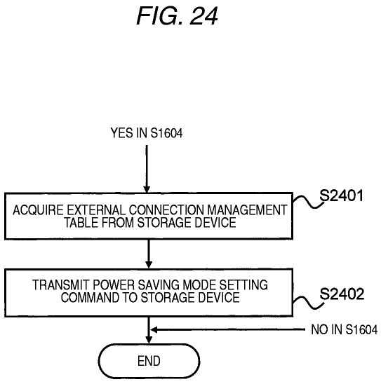

FIG. 24 is a diagram illustrating a difference between the pool physical capacity reducing process according to the second embodiment and the pool physical capacity reducing process according to the first embodiment.

The processes of S2401 and S2402 shown in FIG. 24 are performed instead of S1606 after S1605 shown in FIG. 16.

In S2401, the physical capacity changing program 4601 acquires the external connection management table 2101 from the storage device 1103.

In S2402, the physical capacity changing program 4601 specifies a real volume mapped onto the external volume corresponding to the target pool volume in the description with reference to FIG. 16 and transmits to the external storage device 2001 a power saving mode setting command indicating the specified real volume, with reference to the external connection management table 2101. Accordingly, the device power saving setting process shown in FIG. 12 is performed by the power saving setting program 4501 in the external storage device 2001. The “pool volume” in the description with reference to FIG. 12 can be replaced with the “real volume.” The table referred to in the device power saving setting process is the real volume management table 4502 and the power status management table 4503 (see FIGS. 45 and 46).

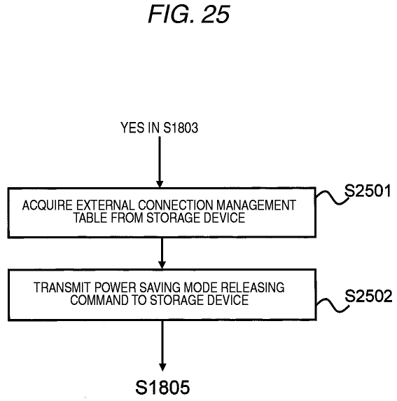

FIG. 25 is a diagram illustrating a difference between the pool physical capacity adding process according to the second embodiment and the pool physical capacity adding process according to the first embodiment.

The processes of S2501 and S2502 shown in FIG. 25 are performed instead of S1804 after YES in S1803 shown in FIG. 18.

In S2501, the physical capacity changing program 4601 acquires the external connection management table 2101 from the storage device 1103.

In S2502, the physical capacity changing program 4601 specifies a real volume mapped onto the external volume corresponding to the target pool volume in the description with reference to FIG. 16 and transmits the power saving mode setting command indicating the specified real volume to the external storage device 2001, with reference to the external connection management table 2101. Accordingly, the device power saving setting process shown in FIG. 12 is performed by the power saving setting program 4501 in the external storage device 2001. The “pool volume” in the description with reference to FIG. 12 can be replaced with the “real volume. The table referred to in the device power saving setting process is the real volume management table 4502 and the power status management table 4503 (see FIGS. 45 and 46).

Hitherto, the second embodiment of the invention is described.

According to the second embodiment, it is possible not to deteriorate the I/O performance with respect to the virtual volume and to reduce the power consumption of the external storage device 2001. Specifically, the data stored in the external volume deleted from the pool are moved to another external volume of the pool and then the power consuming status of all the HDDs in the physical device constituting the real volume mapped onto the external volume as the deletion target is changed to the power saving mode.

### Third Embodiment

A third embodiment of the invention will be described now. The difference from the second embodiment is mainly described and the description common to the second embodiment is omitted or simplified.

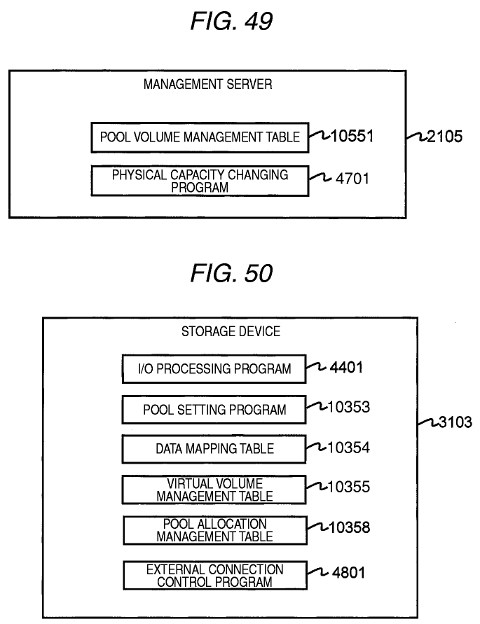

In the third embodiment, as shown in FIG. 49, a physical capacity changing program 4701 executed by a management server 2105 according to the third embodiment has a function different from that of the physical capacity changing program 4601 according to the second embodiment.

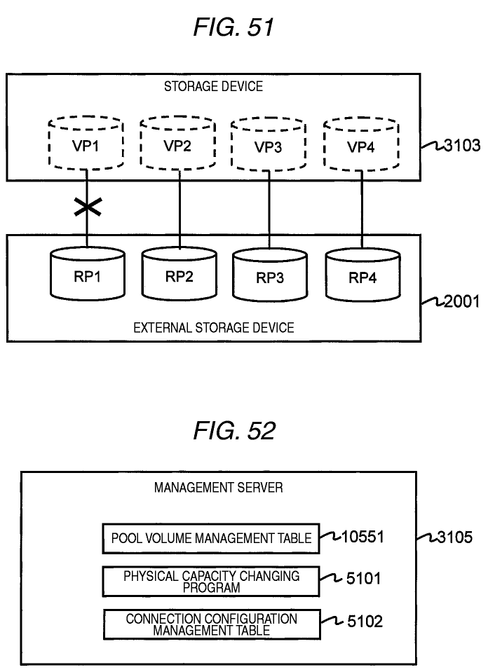

As shown in FIG. 50, the external connection control program 4801 is performed by a storage device 3103 according to the third embodiment. As shown in FIG. 51, the mapping of the real volume onto the external volume is deleted or the real volume is mapped onto the external volume by the program 4801.

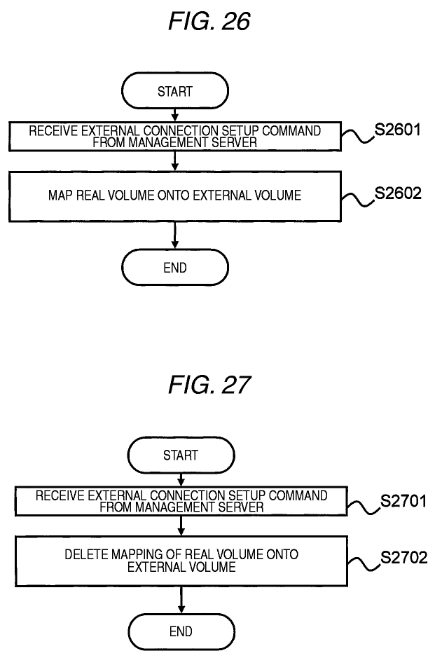

FIG. 26 is a diagram illustrating a flow of the external connection setting process.

In S2601, the external connection control program 4801 receives an external connection setup command from the management server 2105. In the external connection setup command, the external volume added to the pool is specified (for example, the name of the external volume is included in the command). In the following description with reference to FIG. 26, the external volume is referred to as the “target external volume.”

In S2602, external connection control program 4801 maps the real volume onto the target external volume. Specifically, for example, the external connection control program 4801 detects a non-used real volume in the external storage device 2001. The program 4801 writes information (external storage device name and real volume name) on the detected real volume to a record including the name of the target external volume in the external connection management table 2101.

FIG. 27 is a diagram illustrating a flow of the external connection teardown process.

In S2701, the external connection control program 4801 receives the external connection teardown command from the management server 2105. In the external connection teardown command, the external volume deleted from the pool is specified, (for example, the name of the external volume is included in the command). The external volume is referred to as the “target external volume” in the following description with reference to FIG. 27.

In S2702, the external connection control program 4801 deletes the mapping of the real volume onto the target external volume. Specifically, for example, the external connection control program 4801 deletes information (external storage device name and real volume name) on the real volume from the record including the name of the target external volume in the external connection management table 2101.

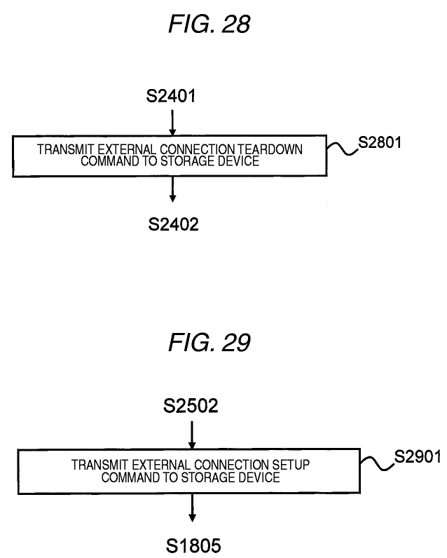

FIG. 28 is a diagram illustrating a difference between the pool physical capacity reducing process according to the third embodiment and the pool physical capacity reducing process according to the second embodiment.

The process of S2801 is performed between S2401 and S2402 (see FIG. 24). That is, in S2801, the physical capacity changing program 4601 transmits to the storage device 1103 the external connection teardown command indicating the external volume (that is, the target external volume in FIG. 27) deleted from the pool.

FIG. 29 is a diagram illustrating a difference between the pool physical capacity adding process according to the third embodiment and the pool physical capacity adding process according to the second embodiment.

The process of S2901 is performed between S2502 (see FIG. 25) and S1805 (see FIG. 18). That is, in S2801, the physical capacity changing program 4601 transmits to the storage device 1103 the external connection setup command indicating the external volume (the target external volume in FIG. 26) added to the pool.

Hitherto, the third embodiment of the invention is described.

According to the third embodiment, the mapping of the real volume onto the external volume is deleted upon the deletion of the external volume from the pool, or the real volume is mapped onto the external volume upon the addition of the external volume to the pool. The real volume deleted in mapping can be used for other applications and thus the efficient use of the memory resources can be expected.

### Fourth Embodiment

A fourth embodiment of the invention will be described now. A difference from the third embodiment is mainly described and the description common to the third embodiment is omitted or simplified.

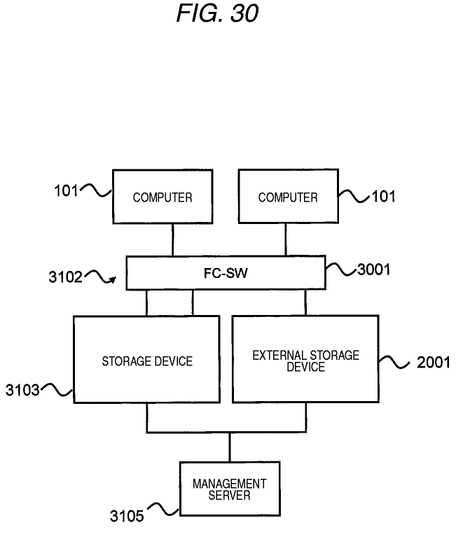

FIG. 30 is a diagram illustrating a configuration of a computer system according to the fourth embodiment of the invention.

An SAN 3102 includes one or more fiber channel switch devices (FC-SW) 3001. The FC-SW 3001 is connected to a computer 101, a storage device 3101, and an external storage device 2001.

As shown in FIG. 52, a physical capacity changing program 5101 having a function different from that of the physical capacity changing program 4701 according to the third embodiment is executed by a management server 3105 according to the fourth embodiment. The management server 3105 includes a connection configuration management table 5102.

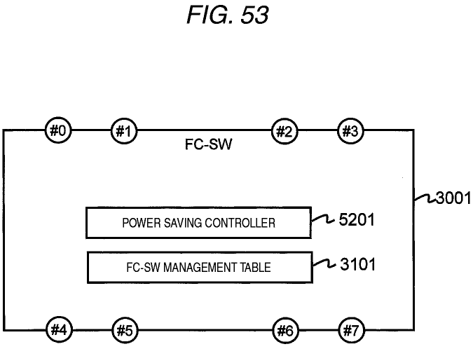

As shown in FIG. 53, the FC-SW 3001 includes plural FC ports (for example, 8 FC ports #0 to #7), a power saving controller 5201, and an FC-SW management table 3101 (where “FC” is an abbreviation of fiber channel).

The power control range of the FC-SW 3001 is classified into an individual range of each port and a range other than port (hereinafter, referred to as “entire FC-SW”) common to all the ports. That is, the FC-SW 3001 can set the power saving mode or the power ON mode every port, and the entire FC-SW can be set to the power saving mode when all the ports are set to the power saving mode. In other words, when at least one port is set to the power ON mode, the power saving mode of the entire FC-SW is deleted (that is, changed to the power ON mode).

The power saving controller 5201 is embodied by allowing a micro processor to execute a computer program and performs a process in accordance with a command from the management server 3105.

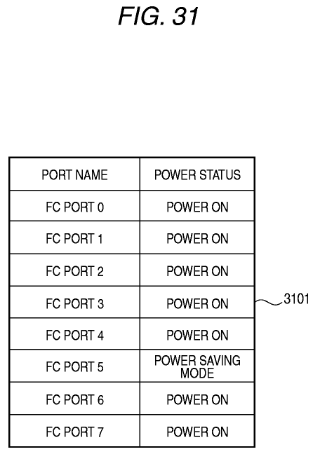

The FC-SW management table 3101 is a table stored in the memory of the FC-SW 3001. As shown in FIG. 31, the power consuming statuses of the FC ports are recorded in the FC-SW management table 3101. The table 3101 is updated by the power saving controller 5201.

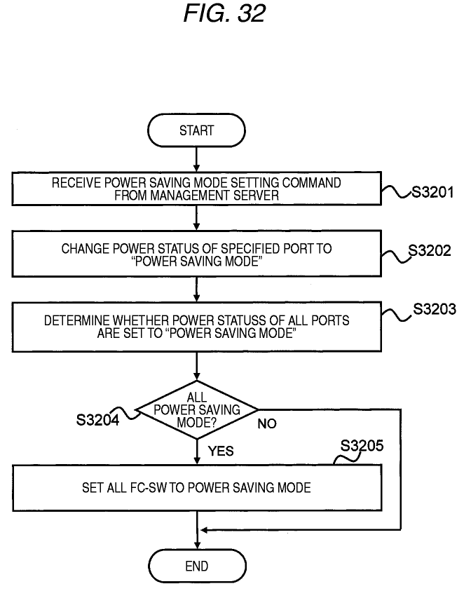

FIG. 32 is a diagram illustrating a flow of an SW power saving setting process. This process is performed by the power saving controller 5201.

In S3201, the power saving controller 5201 receives a power saving mode setting command from the management server 3105. In the command, the FC port as a power saving target is specified (for example, the port name is included in the command). Hereinafter, the FC port as the power saving target is referred to as “target FC port” in the description with reference to FIG. 32.

In S3202, the power saving controller 5201 changes the power status of the target FC port to the “power saving mode” in the FC-SW management table 3101.

In S3203, the power saving controller 5201 determines whether all the FC ports are set to the “power saving mode” in the FC-SW management table 3101.

When the determination result of S3203 is negative (NO in S3204), the SW power saving setting process is ended.

When the determination result of S3203 is affirmative (YES in S3204), the power saving controller 5201 sets the entire FC-SW to the power saving mode in S3205.

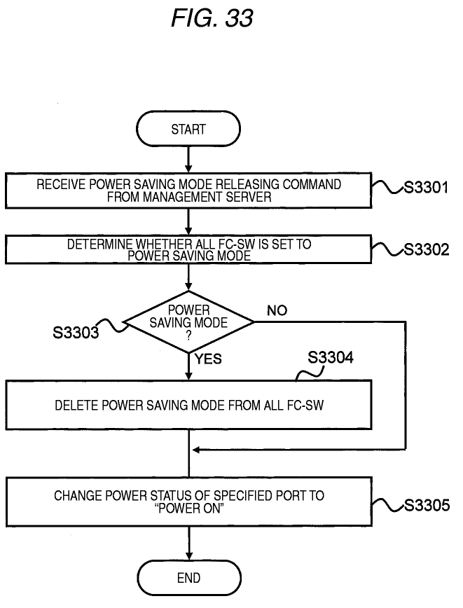

FIG. 33 is a diagram illustrating a flow of the SW power saving releasing process.

In S3301, the power saving controller 5201 receives a power saving mode releasing command from the management server 3105. In the command, the FC port as a power saving release target is specified (for example, the port name is included in the command). Hereinafter, the FC port as the power saving release target is referred to as “target FC port” in the description with reference to FIG. 33.

In S3302, the power saving controller 5201 determines whether the entire FC-SW is set to the power saving mode.

When the determination result of S3302 is negative (NO in S3303), the process of S3304 is skipped and the process of S3305 is performed.

When the determination result of S3302 is affirmative (YES in S3303), the power saving controller 5201 deletes the power saving mode of the entire FC-SW in S3304.

In S3305, the power saving controller 5201 changes the power status of the target FC port to the “power ON mode” in the FC-SW management table 3101.

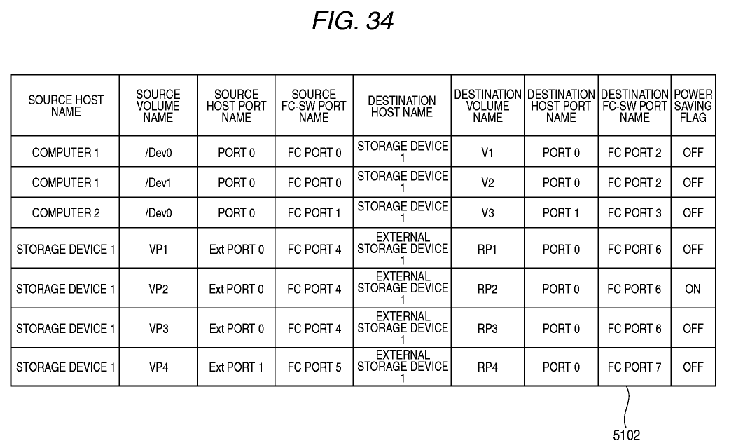

FIG. 34 is a diagram illustrating a configuration of the connection configuration management table 5102.

The table 5102 is a table managed by the management server 3105. The table 5102 describes information on the configuration of each connection and a power saving flag is prepared for each connection. The connection having a power saving flag of “OFF” means a connection in use and the connection having a power saving flag of “ON” means a non-used connection.

Here, the “connection” means a path and includes the following elements of (34-1) to (34-8) as shown in FIG. 34: (34-1) source host name (name of source host); (34-2) source volume name (name of source volume); (34-3) source host port name (name of source host port); (34-4) source FC-SW port name (name of FC port connected to source host port); (34-5) destination host name (name of destination host); (34-6) destination volume name (name of destination volume); (34-7) destination host port name (name of destination host port); and (34-8) destination FC-SW port name (name of FC port connected to destination host port).

Here, the “source host” means an upstream device when it is assumed that the computer 101 is upstream and the external storage device 2001 is downstream. The “destination host’ means a downstream device. Specifically, for example, paying attention to the computer 101 and the storage device 3103, the computer 101 is the source host and the storage device 3103 is the destination host. Paying attention to the storage device 3103 and the external storage device 2001, the storage device 3103 is the source host and the external storage device 2001 is the destination host.

The “source volume” means a volume of the source host. For example, the source volume is a volume (for example, the volume name is “/Dev0”) managed by mounting a virtual volume in the computer 101 and is an external volume in the storage device 3103.

The “destination volume” means a volume of the destination host. For example, the destination volume is an external volume in the storage device 3103 and a real volume in the external storage device 2001.

The “source host port” means a port of the source host and the “destination host port” means a port of the destination host.

FIG. 35 is a diagram illustrating a difference between the pool physical capacity reducing process according to the fourth embodiment and the pool physical capacity reducing process according to the third embodiment.

The physical capacity changing program 5101 performs the SW power saving instructing process (S3501) after S2402 (see FIG. 24).

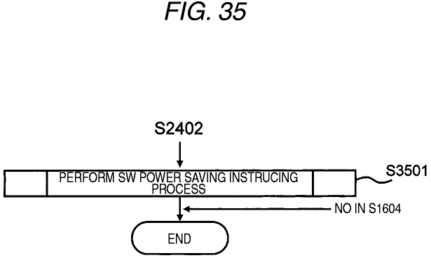

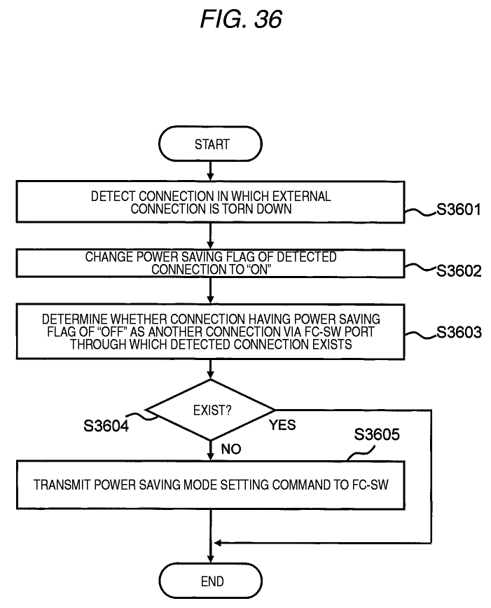

FIG. 36 is a diagram illustrating a flow of the SW power saving instructing process.

In S3601, the physical capacity changing program 5101 detects a connection with the torn-down external connection. The “connection with a torn-down external connection” means a connection including an external volume and a real volume with the deleted mapping on the external.

In S3602, the physical capacity changing program 5101 changes the power saving flag, which corresponds to the connection detected in S3601 (referred to as “target connection” in the following description with reference to FIG. 36), in the connection configuration management table 5102 to “ON.”

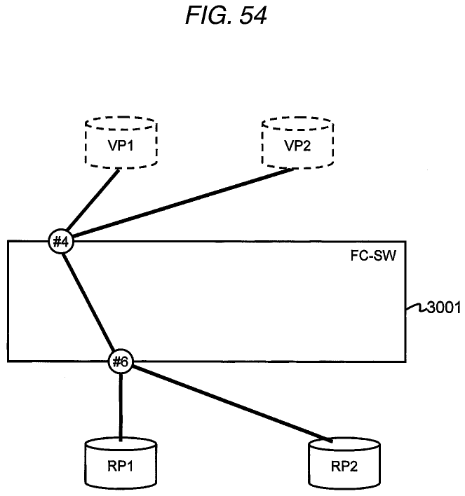

In S3603, the physical capacity changing program 5101 determines whether a different connection via the FC port through which the target connection passes and having a power saving flag of “OFF” exists. For example, in FIG. 54, when the target connection is C1 and the power saving flag of another connection C2 (of which the source FC port and the destination port are both the same as those of the target connection C1) is “OFF”, the determination result of S3603 is affirmative. On the contrary, when the power saving flag of the another connection C2 is “ON”, the determination result of S3603 is negative. That is, at least one of source FC port #4 and source FC port #6 in the target connection C1 does not pass through any other connection having a power saving flag of “OFF”, the determination result of S3603 is negative.

When the determination result of S3603 is affirmative (YES in S3604), the SW power saving instructing process is ended.

When the determination result of S3603 is negative (NO in S3604), the physical capacity changing program 5101 transmits the power saving mode setting command to the FC-SW 3001 in S3605. In the command, an FC port not passing through any other connection with a power saving flag of “OFF” is specified between the source FC port and the destination FC port in the target connection.

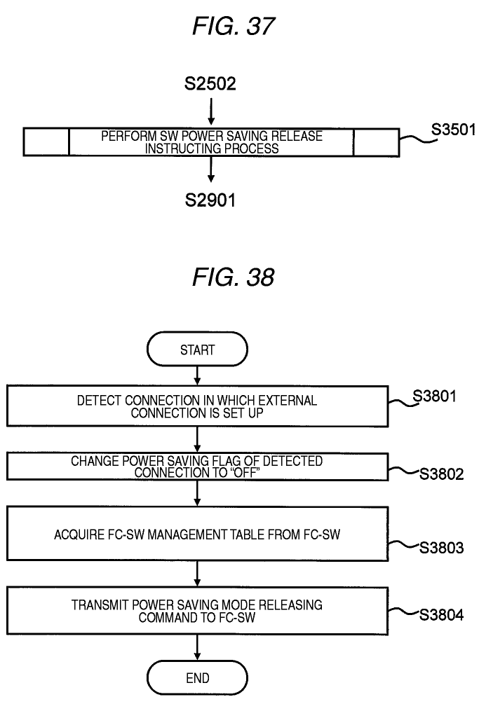

FIG. 37 is a diagram illustrating a difference between the pool physical capacity adding process according to the fourth embodiment and the pool physical capacity adding process according to the third embodiment.

The physical capacity changing program 5101 performs the SW power saving deletion instructing process (S3501) after S2502 (see FIG. 25).

FIG. 38 is a diagram illustrating a flow of the SW power saving deletion instructing process.

In S3801, the physical capacity changing program 5101 detects a connection with a set-up external connection. The “connection with a set-up external connection” means a connection including an external volume and a real volume with the mapping on the external.

In S3802, the physical capacity changing program 5101 changes the power saving flag, which corresponds to the connection detected in S3801 (referred to as “target connection” in the following description with reference to FIG. 38), in the connection configuration management table 5102 to “OFF.”

In S3803, the physical capacity changing program 5101 acquires the FC-SW management table 3101 from the FC-SW 3001.

In S3804, the physical capacity changing program 5101 transmits the power saving mode setting command to the FC-SW 3001. In the command, an FC port of which the power status in the FC-SW management table 3101 is the “power OFF” is designated out of the source FC port and the destination FC port in the target connection.

Hitherto, the fourth embodiment of the invention is described.

According to the fourth embodiment, the power consuming status in the FC port is changed to the power saving mode with the deletion of the mapping of the real volume onto the external volume. Accordingly, it is possible to reduce the power consumption of the storage system including the storage device 3103, the FC-SW 3001, and the external storage device 2001.

Although the exemplary embodiments of the invention have been described, the embodiments are only examples of the invention and are not intended to limit the scope of the invention. The invention can be modified in various forms. For example, the pool volume deleted from the pool may be used for other applications. For example, in one of the first to fourth embodiments, the process of deleting the pool volume (external volume) from the pool may not be performed. For example, in the fourth embodiment, the deletion of the mapping of the real volume onto the external volume may not be performed.

What is claimed is:

1. A storage system receiving from a computer an I/O command that is a writing command or a reading command, the storage system comprising:
a plurality of physical memory devices;
a plurality of pool volumes based on the plurality of physical memory devices and including a plurality of real areas;
an allocation-on-use (AOU) volume that is a virtual logical volume including a plurality of virtual areas; and
a controller allocating a non-allocated real area in a pool including the plurality of pool volumes to a virtual area corresponding to an address specified by the writing command when the writing command is received from the computer and no real area is allocated to the virtual area, and writing data corresponding to the received writing command to the allocated real area,
wherein the plurality of pool volumes include a first pool volume and a second pool volume based on a physical memory device other than the physical memory device constituting the first pool volume,
wherein the controller
(1-1) moves data stored in all the real areas in the first pool volume allocated to the AOU volume to the second pool volume, and
(1-2) changes a power consuming status of the physical memory device constituting the first pool volume to a power saving mode after the (1-1).

2. The storage system according to claim 1, further comprising:
a storage device;
an external storage device connected to the storage device;
a switch device connected to the storage device and the external storage device; and
a management server,
wherein each pool volume includes a virtual pool volume and a real pool volume mapped onto the virtual pool volume, the real pool volume is a logical volume based on the plurality of physical memory devices, and the virtual pool volume is a virtual pool volume,
wherein the controller includes a first controller having a memory and a second controller,
wherein the storage device includes the first controller and a plurality of the virtual pool volumes,
wherein the memory stores:
a data mapping table indicating the correspondence of allocation between the virtual areas and the real areas;
a pool management table indicating what pool the pool volumes belong to, what parity group the pool volumes are based on, and whether the pool volumes are a power saving target; and
an external connection table indicating the correspondence of mapping between the virtual pool volumes and the real pool volumes,
wherein the data mapping table is updated by the first controller every when the real areas are allocated to the virtual areas,
wherein the first controller allocates the real area in one virtual pool volume to the virtual area corresponding to an address specified by the writing command in response to the writing command from the computer and transmits the writing command specifying the real pool volume mapped onto the one virtual pool volume to the second controller,
wherein the second controller writes the data in the real area in the real pool volume in accordance with the writing command from the first controller,
wherein in the (1-1), the first controller allocates the real area as a destination to the virtual area, which the real area as a source is allocated to, instead of the real area as the source by updating the data mapping table,
wherein the real area as the source is the real area in the first pool volume and is allocated to one virtual area and the real area as the destination is the real area in the second pool volume and stores the data moved from the real area as the source,
wherein (2-1) the first controller excludes the virtual pool volumes constituting the first pool volume from the pool by updating the pool mapping table,
wherein (2-2) the first controller makes a first determination on whether all the other pool volumes based on a target parity group, which is a parity group constituting the first pool volume, is a power saving target with reference to the pool management table,
wherein (2-3) when the first determination result is negative, the first controller sets the first pool volume to the power saving target by updating the pool management table without changing the power consuming statuses of all the physical memory devices constituting the target parity group to a power saving mode,
wherein (2-4) when the first determination result is affirmative, the second controller changes the power consuming statuses of the physical memory devices constituting the real pool volume of the first pool volume to the power saving mode in the (1-2),
wherein (2-5) the first controller deletes the mapping of the real pool volume onto the virtual pool volume in the first pool volume by updating the external connection table,
wherein the switch device has a plurality of ports, each of which is one of a first port connected to the storage device and a second port connected to the external storage device,
wherein the management server manages a connection configuration indicating what real pool volume each virtual pool volume is mapped onto through the first port or the second port of the switch device, and
(2-A) transmits to the first controller a command to reduce the virtual pool volume of the first pool volume;
(2-B) transmits to the first controller a command to delete the mapping of the real pool volume of the first pool volume;
(2-C) transmits to the switch device a power saving command to specify a port not corresponding to the other virtual pool volumes and the other real pool volumes in use among the first port corresponding to the virtual pool volume of the first pool volume and the second port corresponding to the real pool volume of the first pool volume; and
(2-D) transmits to the second controller a power saving command to set the real pool volume of the first pool volume to the power saving mode,
wherein the (2-1) is performed in response to the reducing command transmitted in the (2-A),
wherein the (2-5) is performed in response to the mapping releasing command transmitted in the (2-B),
wherein the switch device changes the power consuming status of the port specified by the power saving command to the power saving mode in response to the power saving command transmitted in the (2-C), and
wherein the (2-2) is performed in response to the power saving command transmitted in the (2-D).

3. The storage system according to claim 1, wherein the controller allocates the real area as a destination to the virtual area, which the real area as a source is allocated to, instead of the real area as the source in the (1-1),
wherein the real area as the transfer source is the real area in the first pool volume and is allocated to one virtual area, and the real area as the transfer destination is the real area in the second pool volume and stores the data moved from the real area as the source, and
wherein the controller performs (2-1) excluding the first pool volume from the pool by updating the pool mapping table.

4. The storage system according to claim 1, further comprising a storage device; and
an external storage device connected to the storage device;
wherein each pool volume includes a virtual pool volume and a real pool volume mapped onto the virtual pool volume,
wherein each real pool volume is a logical volume based on the plurality of physical memory devices and is disposed in the external storage device,
wherein each virtual pool volume is a virtual pool volume and is disposed in the storage device,
wherein an I/O with respect to one real area in the virtual pool volume is performed on the real area, corresponding to the one real area, in the real pool volume mapped onto the virtual pool volume,
wherein the controller includes a first controller disposed in the storage device and a second controller disposed in the external storage device, and
wherein the second controller changes the power consuming statuses of the physical memory devices constituting the real pool volume of the first pool volume to the power saving mode in the (1-2).

5. The storage system according to claim 3, wherein the first controller performs (3-1) deleting the mapping of the real pool volume onto the virtual pool volume in the first pool volume.

6. The storage system according to one of claims 1, wherein a switch device is connected to the storage device and the external storage device,
wherein the switch device includes a plurality of ports, and each port is one of a first port connected to the storage device and a second port connected to the external storage device,
wherein a connection configuration in which one virtual pool volume is mapped onto one real pool volume through one of the first port and the second port of the switch device is managed, and
wherein the power consuming status of the port not corresponding to any of the other virtual pool volumes and the other real pool volumes in use is made to be the power saving mode among the first port corresponding to the virtual pool volume of the first pool volume and the second port corresponding to the real pool volume of the first pool volume.

7. The storage system according to claim 3, further comprising a source determining unit; and
a destination determining unit,
wherein the source determining unit determines as the first pool volume of the plurality of pool volumes the pool volume having the memory capacity satisfying a capacity reducing condition specified by a pool capacity reducing command in response to the pool capacity reducing command that is a command to reduce the memory capacity of the pool desired by a manager, and
wherein the destination determining unit determines what of the plurality of pool volumes the second pool volume is.

8. The storage system according to claim 3, further comprising a prediction unit,
wherein the prediction unit calculates a predicted I/O performance value and a predicted power consumption value and outputs information indicating the predicted I/O performance value and the predicted power consumption value, when the first pool volume is excluded from the pool,
wherein the (2-1) is performed when a specific command is given from a manager after outputting the information indicating the predicted I/O performance value and the predicted power consumption value, and
wherein the predicted I/O performance value is a predicted value of the I/O performance of the AOU volume to which the real area is allocated from the pool including the first pool volume.

9. The storage system according to claim 1, wherein the controller manages a pool allocation management table indicating what real areas can be allocated to the AOU volume every volume,
wherein the first pool volume is a pool volume specified on the basis of the pool allocation management table and having the smallest total capacity of the real areas allocated to the AOU volume, and
wherein the second pool volume is a pool volume specified on the basis of the pool allocation management table and having the secondly smallest total capacity of the real areas allocated to the AOU volume.

10. The storage system according to claim 1, wherein the controller manages the pool allocation management table indicating what I/O frequency occurs every volume,
wherein the first pool volume is a pool volume specified on the basis of the pool allocation management table and having the smallest I/O frequency, and
wherein the second pool volume is a pool volume specified on the basis of the pool allocation management table and having the secondly smallest I/O frequency.

11. The storage system according to claim 1, wherein each parity group includes two or more physical memory devices of the plurality of physical memory devices, and
wherein the first pool volume is a pool volume in the parity group having the smallest number of pool volumes to be non-saved in power.

12. The storage system according to claim 1, wherein the second pool volume is a pool volume other than the first pool volume in the pool, and
wherein the controller homogeneously disperses the data stored in all the real areas, which are allocated to the AOU volume, in the first pool volume into a plurality of the second pool volumes in the (1-1).

13. The storage system according to claim 1, wherein the second pool volume is one or more pool volumes other than the first pool volume in the pool, and
wherein the controller disperses to one or more second pool volumes the data stored in all the real areas, which are allocated to the AOU volume, in the first pool volume in the (1-1) so that the I/O frequencies of all the pool volumes are equal.

14. The storage system according to claim 12, wherein the first pool volume is one of a pool volume having the smallest total capacity of the real areas allocated to the AOU volume and a pool volume having the smallest I/O frequency.

15. The storage system according to claim 13, wherein the first pool volume is one of a pool volume having the smallest total capacity of the real areas allocated to the AOU volume and a pool volume having the smallest I/O frequency.
